(19) United States
(12) Patent Application Publication
(10) Pub. No.: US 2024/0403580 A1
(43) Pub. Date: Dec. 5, 2024

(54) DEVICE ASSIGNMENT SYSTEM AND METHOD

(71) Applicants: Allflex USA LLC, WILMINGTON, DE (US); S.C.R. (ENGINEERS) LIMITED, Netanya (IL)

(72) Inventors: Brandt KREUSCHER, DFW Airport, TX (US); Amir COHEN, Netanya (IL); Guy FRIDKOVSKI, Netanya (IL); Tzvi SHTERENBERG, Netanya (IL); Alon FICHMAN, Netanya (IL); Arthur RABINOVITZ, Netanya (IL)

(21) Appl. No.: 18/783,477

(22) Filed: Jul. 25, 2024

Related U.S. Application Data
(63) Continuation of application No. 18/002,486, filed on Dec. 20, 2022, now Pat. No. 12,099,893.

(30) Foreign Application Priority Data
Jul. 1, 2020 (IL) 275812

(51) Int. Cl. G06K 7/10; A01K 11/00

(52) U.S. Cl. CPC G06K 7/10366; A01K 11/006

(57) ABSTRACT

A tag assignment system, comprising a processing circuitry and being communicatively connected to a data repository comprising records, each of which (i) being associated with a respective distinct animal of a plurality of animals, and (ii) including a Unique Animal Identifier (UAI) associated with the respective distinct animal; the processing circuitry is configured to: substantially simultaneously: (i) obtain an ID reading of an animal identification tag attached to a given animal of the animals from a first tag reading device, wherein the ID reading including the UAI uniquely identifying the given animal, and (ii) obtain a tag reading of a second tag attached to the given animal from a second tag reading device, the tag reading including tag identification information uniquely identifying the second tag; and cause update of the data repository to assign the tag identification information to a given record of the records associated with the UAI.

### TECHNICAL FIELD

The presently disclosed subject matter relates to animal identification and assignment of devices to animals according to the animal identification results.

### BACKGROUND

Animals may be tagged for various purposes. One purpose of tagging an animal is for identification purposes. For example, an animal can be identified by an electronic identification (eID), such as an animal identification tag (also referred to herein as: “animal ID Tag” or “ID Tag”) that is attached thereto, for uniquely identifying the animal. Of course, an EID tag is not the only way an animal can be identified. Animals can additionally or alternatively be identified using other systems, methods or techniques, such as non-electronic identification tags, visual identification tags, camera based identification systems, identification marks directly on animals (either of the latter three identifiers can include digits, letters, symbols, or any combination thereof, etc.), readable barcodes, facial (or other body part) recognition, etc. Identification of an animal is also important for physiological monitoring thereof. An animal can be monitored (and optionally also identified, e.g. in case the ID tag is also used for physiological monitoring) by an animal monitoring device such as a tag (also referred to herein as: “Monitoring Tag”) that is designed to collect information relating to the animal's activity and health status and optionally to transmit the obtained information wirelessly to an external server. Monitoring tags may be ear tags or other types of tags, such as neck tags. It is thus naturally crucial to have the ability to identify the animal that is monitored by the monitoring tag by associating the animal (using an animal identification method, device, identifier, or system) with the monitoring tag (using an identifier thereof). In some cases, additional types of identification devices can be attached to an animal for various purposes. Including for example, tags that indicate some feature or detail about the animal's health, origin, status, etc. Such identification devices are also included in the scope of the presently disclosed subject matter.

In one example of identification systems discussed herein, current tagging systems are independent of one another and they are not automatically associated with an identifier of the animal to which they are attached. The identification tag, or any other identifier as indicated herein, identifies the animal, but the system that identifies the animal does not read the monitoring tag, and does not know to associate the animal identifier (e.g. the identifier associated with the ID tag) with the monitoring tag identifier (associated with the monitoring tag). Due to the fact that it is critical to be able to associate an animal identifier (e.g. the identifier associated with the ID tag) with the monitoring tag identifier (associated with the monitoring tag), such association is made manually. However, such manual assignment task is cumbersome, ineffective, and in some cases even impossible, especially in large farms in which hundreds, thousands, or tens of thousands of animals are grown. The task gets even more complicated due to the fact that monitoring tags (or other devices for that purpose) are reusable and may be transferred from animal to animal.

There is thus a need in the art for a new method and system for animal identifier reading, assignment, tracking, and/or correlation.

### GENERAL DESCRIPTION

In accordance with a first aspect of the presently disclosed subject matter, there is provided a tag assignment system, comprising: one or more tag reading devices capable of reading tags attached to animals; and a processing circuitry; wherein: the tag assignment system is communicatively connected to a data repository comprising one or more records, each of the records (i) being associated with a respective distinct animal of a plurality of animals, and (ii) including a unique animal identifier associated with the respective distinct animal; and the processing circuitry is configured to: substantially simultaneously: (i) obtain an ID reading of an animal identification tag attached to a given animal of the animals from a first tag reading device of the tag reading devices, wherein the first tag reading device is operating according to a first communication protocol, and the ID reading including at least the unique animal identifier uniquely identifying the given animal, and (ii) obtain a tag reading of a second tag, other than the animal identification tag, attached to the given animal from a second tag reading device of the tag reading devices, wherein the second tag reading device is operating according to a second communication protocol, and the tag reading including at least tag identification information uniquely identifying the second tag attached to the given animal; and cause update of the data repository to assign the tag identification information to a given record of the records associated with the unique animal identifier of the given animal.

In one embodiment of the presently disclosed subject matter and/or embodiments thereof, the processing circuitry is further configured to cause a second update of the data repository to delete the tag identification information from a second record of the records, other than the given record, wherein the second record is not associated with the unique animal identifier of the given animal.

In one embodiment of the presently disclosed subject matter and/or embodiments thereof, the second tag is an animal monitoring tag.

In one embodiment of the presently disclosed subject matter and/or embodiments thereof, the first communication protocol is different than the second communication protocol.

In one embodiment of the presently disclosed subject matter and/or embodiments thereof, the first tag reading device is different than the second tag reading device.

In one embodiment of the presently disclosed subject matter and/or embodiments thereof, the animal identification tag is an Radio Frequency Identification (RFID) tag and the first communication protocol is an RFID protocol.

In one embodiment of the presently disclosed subject matter and/or embodiments thereof, the second tag is an Infra-Red (IR) tag and the second communication protocol is an IR protocol.

In one embodiment of the presently disclosed subject matter and/or embodiments thereof, the ID reading and the tag reading are obtained when the given animal is located at a confined area, so that (a) the animal identification tag is within a first reading range of the first tag reading device, and (b) the second tag is within a second reading range of the second tag reading device.

In one embodiment of the presently disclosed subject matter and/or embodiments thereof, the confined area is within a feeding station.

In one embodiment of the presently disclosed subject matter and/or embodiments thereof, the confined area is within a milking cabin.

In one embodiment of the presently disclosed subject matter and/or embodiments thereof, the confined area is a portion of an animal passage allowing only one of the animals to be located within the confined area during obtainment of the ID reading and the tag reading.

In one embodiment of the presently disclosed subject matter and/or embodiments thereof, the animal passage is a sorting gate.

In one embodiment of the presently disclosed subject matter and/or embodiments thereof, the confined area is an area defined by the first reading range and the second reading range.

In one embodiment of the presently disclosed subject matter and/or embodiments thereof, the animal passage comprises conductive rails, and wherein at least one of (a) the first tag reading device, or (b) the second tag reading device, are insulated from the conductive rails.

In one embodiment of the presently disclosed subject matter and/or embodiments thereof, the processing circuitry is further configured, after the substantially simultaneous obtainment, to substantially simultaneously: (a) obtain a second ID reading of the animal identification tag attached to the given animal from a third tag reading device of the tag reading devices, wherein the third tag reading device is operating according to the first communication protocol, and the second ID reading including at least the unique animal identifier uniquely identifying the given animal, and (b) obtain a second tag reading of the second tag attached to the given animal from a fourth tag reading device of the tag reading devices, wherein the fourth tag reading device is operating according to the second communication protocol, and the second tag reading including at least the tag identification information uniquely identifying the second tag attached to the given animal; and wherein causing the update of the data repository is made upon the ID reading being identical to the second ID reading and the tag reading being identical to the second tag reading.

In one embodiment of the presently disclosed subject matter and/or embodiments thereof, (a) the first tag reading device and the third tag reading device are different tag reading devices, and (b) the second tag reading device and the fourth tag reading device are different tag reading devices.

In one embodiment of the presently disclosed subject matter and/or embodiments thereof, the second ID reading and the second tag reading are obtained when the given animal is located at a second confined area other than the confined area, so that (i) the animal identification tag is within a third reading range of the second animal identification tag reading device, and (ii) the animal monitoring tag is within a fourth reading range of the second animal monitoring tag reading device.

In one embodiment of the presently disclosed subject matter and/or embodiments thereof, the processing circuitry is further configured to alert a user upon failure to obtain the ID reading or the tag reading.

In accordance with a second aspect of the presently disclosed subject matter, there is provided a tag assignment method, comprising: substantially simultaneously: (i) obtaining an ID reading of an animal identification tag attached to a given animal of the animals from a first tag reading device of one or more tag reading devices capable of reading tags attached to animals, wherein the first tag reading device is operating according to a first communication protocol, and the ID reading including at least the unique animal identifier uniquely identifying the given animal, and (ii) obtaining a tag reading of a second tag, other than the animal identification tag, attached to the given animal from a second tag reading device of the tag reading devices, wherein the second tag reading device is operating according to a second communication protocol, and the tag reading including at least tag identification information uniquely identifying the second tag attached to the given animal; and causing update of a data repository comprising one or more records, each of the records (i) being associated with a respective distinct animal of a plurality of animals, and (ii) including a unique animal identifier associated with the respective distinct animal, wherein the update includes assigning the tag identification information to a given record of the records associated with the unique animal identifier of the given animal.

In one embodiment of the presently disclosed subject matter and/or embodiments thereof, the method further comprises causing a second update of the data repository to delete the tag identification information from a second record of the records, other than the given record, wherein the second record is not associated with the unique animal identifier of the given animal.

In one embodiment of the presently disclosed subject matter and/or embodiments thereof, the second tag is an animal monitoring tag.

In one embodiment of the presently disclosed subject matter and/or embodiments thereof, the first communication protocol is different than the second communication protocol.

In one embodiment of the presently disclosed subject matter and/or embodiments thereof, the first tag reading device is different than the second tag reading device.

In one embodiment of the presently disclosed subject matter and/or embodiments thereof, the animal identification tag is an Radio Frequency Identification (RFID) tag and the first communication protocol is an RFID protocol.

In one embodiment of the presently disclosed subject matter and/or embodiments thereof, the second tag is an Infra-Red (IR) tag and the second communication protocol is an IR protocol.

In one embodiment of the presently disclosed subject matter and/or embodiments thereof, the ID reading and the tag reading are obtained when the given animal is located at a confined area, so that (a) the animal identification tag is within a first reading range of the first tag reading device, and (b) the second tag is within a second reading range of the second tag reading device.

In one embodiment of the presently disclosed subject matter and/or embodiments thereof, the confined area is within a feeding station.

In one embodiment of the presently disclosed subject matter and/or embodiments thereof, the confined area is within a milking cabin.

In one embodiment of the presently disclosed subject matter and/or embodiments thereof, the confined area is a portion of an animal passage allowing only one of the animals to be located within the confined area during obtainment of the ID reading and the tag reading.

In one embodiment of the presently disclosed subject matter and/or embodiments thereof, the animal passage is a sorting gate.

In one embodiment of the presently disclosed subject matter and/or embodiments thereof, the confined area is an area defined by the first reading range and the second reading range.

In one embodiment of the presently disclosed subject matter and/or embodiments thereof, the animal passage comprises conductive rails, and wherein at least one of (a) the first tag reading device, or (b) the second tag reading device, are insulated from the conductive rails.

In one embodiment of the presently disclosed subject matter and/or embodiments thereof, the method further comprises, after the substantially simultaneous obtainment, substantially simultaneously: (a) obtaining a second ID reading of the animal identification tag attached to the given animal from a third tag reading device of the tag reading devices, wherein the third tag reading device is operating according to the first communication protocol, and the second ID reading including at least the unique animal identifier uniquely identifying the given animal, and (b) obtaining a second tag reading of the second tag attached to the given animal from a fourth tag reading device of the tag reading devices, wherein the fourth tag reading device is operating according to the second communication protocol, and the second tag reading including at least the tag identification information uniquely identifying the second tag attached to the given animal; and wherein causing the update of the data repository is made upon the ID reading being identical to the second ID reading and the tag reading being identical to the second tag reading.

In one embodiment of the presently disclosed subject matter and/or embodiments thereof, (a) the first tag reading device and the third tag reading device are different tag reading devices, and (b) the second tag reading device and the fourth tag reading device are different tag reading devices.

In one embodiment of the presently disclosed subject matter and/or embodiments thereof, the second ID reading and the second tag reading are obtained when the given animal is located at a second confined area other than the confined area, so that (i) the animal identification tag is within a third reading range of the second animal identification tag reading device, and (ii) the animal monitoring tag is within a fourth reading range of the second animal monitoring tag reading device.

In one embodiment of the presently disclosed subject matter and/or embodiments thereof, the method further comprises alerting a user upon failure of obtaining the ID reading or the tag reading.

In accordance with a second aspect of the presently disclosed subject matter, there is provided a non-transitory computer readable storage medium having computer readable program code embodied therewith, the computer readable program code, executable by at least one processing circuitry of a computer to perform a method comprising: substantially simultaneously: (i) obtaining an ID reading of an animal identification tag attached to a given animal of the animals from a first tag reading device of one or more tag reading devices capable of reading tags attached to animals, wherein the first tag reading device is operating according to a first communication protocol, and the ID reading including at least the unique animal identifier uniquely identifying the given animal, and (ii) obtaining a tag reading of a second tag, other than the animal identification tag, attached to the given animal from a second tag reading device of the tag reading devices, wherein the second tag reading device is operating according to a second communication protocol, and the tag reading including at least tag identification information uniquely identifying the second tag attached to the given animal; and causing update of a data repository comprising one or more records, each of the records (i) being associated with a respective distinct animal of a plurality of animals, and (ii) including a unique animal identifier associated with the respective distinct animal, wherein the update includes assigning the tag identification information to a given record of the records associated with the unique animal identifier of the given animal.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of exemplary device assignment system, in accordance with the presently disclosed subject matter;

FIG. 2 is a block diagram schematically illustrating one example of a device assignment system, in accordance with the presently disclosed subject matter;

FIG. 3 is a flowchart illustrating one example of a sequence of operations carried out for device assignment, in accordance with the presently disclosed subject matter; and

FIG. 4 is another flowchart illustrating another optional part of the sequence of operations carried out for device assignment, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “causing”, “updating”, “alerting” or the like, include action and/or processes of a computer that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

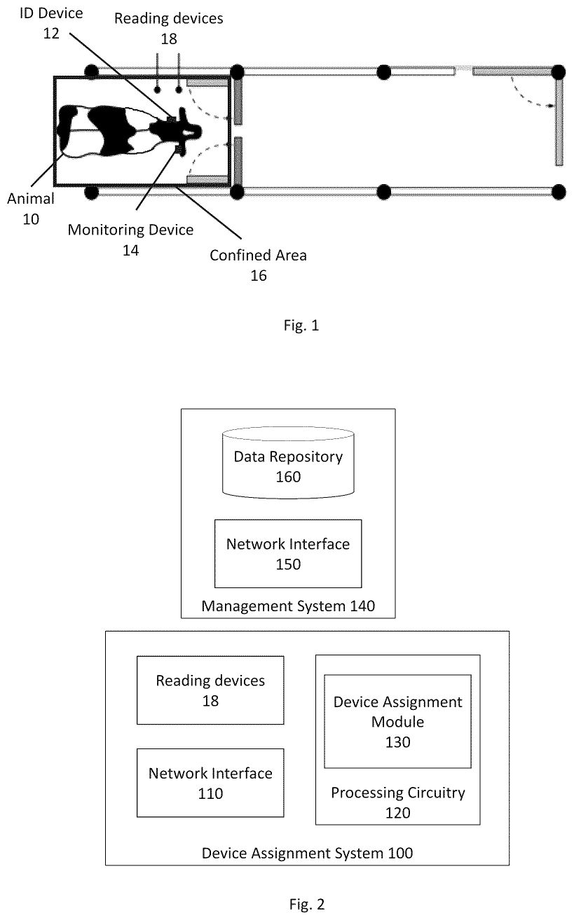

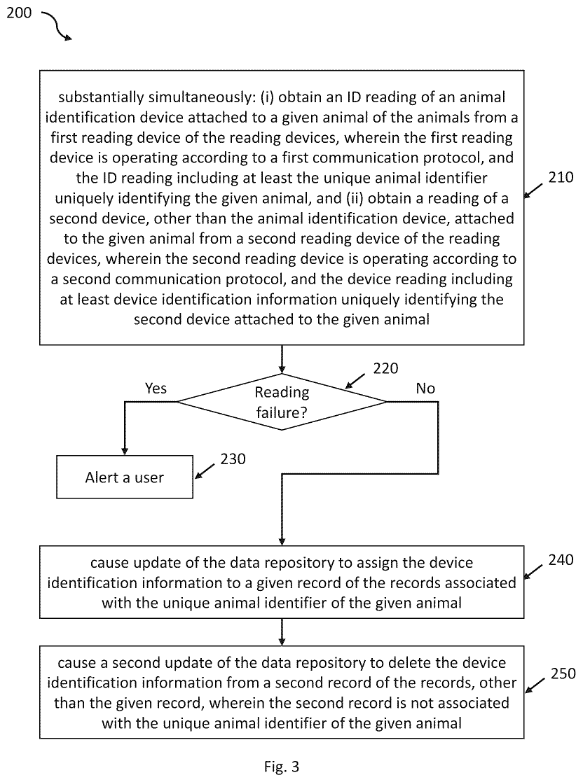

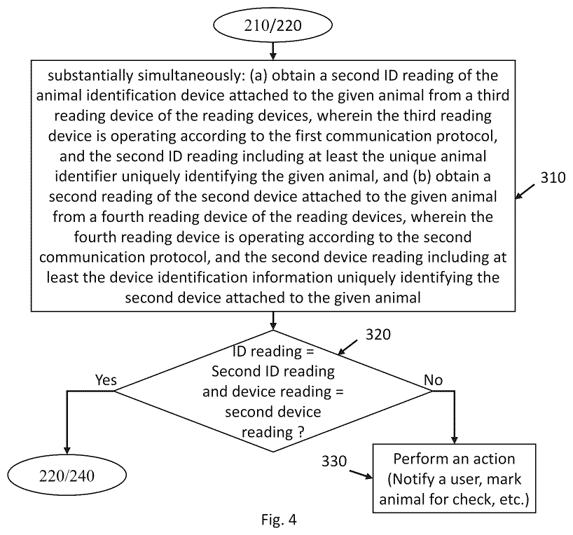

In embodiments of the presently disclosed subject matter, fewer, more and/or different stages than those shown in FIGS. 3 and 4 may be executed. In embodiments of the presently disclosed subject matter one or more stages illustrated in FIGS. 3 and 4 may be executed in a different order and/or one or more groups of stages may be executed simultaneously. FIGS. 1 and 2 illustrates a general schematic of the system architecture in accordance with an embodiment of the presently disclosed subject matter. Each module in FIGS. 1 and 2 can be made up of any combination of software, hardware and/or firmware that performs the functions as defined and explained herein. The modules in FIGS. 1 and 2 may be centralized in one location or dispersed over more than one location, as detailed herein. In other embodiments of the presently disclosed subject matter, the system may comprise fewer, more, and/or different modules than those shown in FIGS. 1 and 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a schematic illustration of exemplary device assignment system, in accordance with the presently disclosed subject matter.

In the illustration, an animal 10 is shown. Although the animal 10 in the illustration is a cow, it is by no means limiting, and the animal 10 can be any other animal (e.g. other types of cattle, pets, fish, livestock, etc.). The animal 10 has two devices attached to it: an identification (ID) device 12 (such as, but not limited to an ID tag) and a monitoring device 14 (such as, but not limited to, a monitoring tag). As indicated herein, the ID device 12 can be a tag that uniquely identifies the animal 10. However, the ID device 12 may alternatively be another type of device used to identify the animal 10 by any of the methods or systems described herein (including electronic identification, visual identification, camera-based identification, facial or body part recognition, barcode, identification marks, etc.). When read by a suitable reading device, the ID device 12 returns a reading that includes at least a unique animal identifier, uniquely identifying the animal 10. When read by a suitable reading device (e.g. a tag reading device), the monitoring device 14 returns a reading that includes monitoring device identification information uniquely identifying the animal monitoring device 14 attached to the animal 10. It is to be noted that additional and/or alternative devices can be attached to the animal, and the ID device 12 and the monitoring device 14 are provided by way of non-limiting examples. As discussed, the animal 10 can be identified using various systems/devices/methods/techniques, including an ID tag, identification marks (e.g. digits, letters, symbols, or any combination thereof, etc.), readable barcodes, facial (or other body parts) recognition, etc., and that the animal 10 can be physiologically monitored using various monitoring devices, including a monitoring tag, a bolus, etc.

The assignment system may further include one or more reading devices 18. The reading devices 18 are capable of reading the devices attached to the animal 10, such as the ID device 12 and the monitoring device 14.

When looking at an example in which two tags are attached to the animal 10 (the ID device 12 is an ID tag and the monitoring device 14 is a monitoring tag), and assuming that both tags operate according to a common communication or tag reading protocol/technique, a single reading device 18 can read both the ID device 12 and the monitoring device 14. For example, if both the ID device 12 and the monitoring device 14 are Radio-Frequency (RF) tags, a single RF reading device can be used to read both tags. Similarly, if both the ID device 12 and the monitoring device 14 are Infra-Red (IR) tags, a single IR reading device can be used to read both tags. It is to be noted that when a single reading device 18 is used there is a need to discriminate between a reading from the ID device 12 and a reading from the monitoring device 14. This can be achieved in various known manners, including, for example, by having each tag designed and/or programmed to respond to a different stimulus from the reading device 18.

When looking at another example, in which there are still two tags attached to the animal 10 (the ID device 12 is an ID tag and the monitoring device 14 is a monitoring tag), however both tags operate according to different communication or tag reading protocols/techniques, each tag can be read by a different reading device 18 operating according to the respective communication protocol. For example, if the ID device 12 is an RF tag and the monitoring device 14 is an IR tag, the ID device 12 has to be read by an RF reading device and the monitoring device 14 has to be read by an IR reading device. It is to be noted that in some cases, a single tag reading device 18 can be able to communicate (or read) with different tags that operate according to different communication protocols or reading techniques (i.e. such tag reading device 18 has the ability to communicate with tags using multiple communication protocols, or reading techniques).

In some cases, the animal 10 can be identified without having an ID device 12 attached thereto. One example is visual identification (e.g. facial, or other body parts, recognition). In such cases, at least one of the reading devices 18 is a visual reading device such as a camera that acquires an image based on which the animal 10 is identified. In such cases, the monitoring device 14 may be an IR or RF tag for example, and the animal 10 is identified by visual identification while the monitoring device 14 is read by a device, or devices, that can read using the respective techniques or protocols.

It is to be further noted that in some cases, one or more of the identification methods may be passive identification methods, such as passive tags. For example, the tags can be a printing of a certain identifier on the animal 10, or they can be stickers of a certain visual identifier attached of the animal, or they can be markings painted on the animal. In such cases, where the tags are visually identifiable (e.g. barcodes), the respective tag reading device 18 can be, for example, a camera capable of acquiring images in the spectrum of the visual tags.

It is to be still further noted that the reading devices 18 have to be placed so that they can obtain readings that can be used to identify the animal 10 (e.g. by reading an ID device 12, or by any other identification method and/or technique) and read the devices (e.g. tags) attached to a single animal at a time. Placement of the reading devices 18 at a position in which due to their reading range they may simultaneously read devices attached to more than one animal may lead to errors in assignment of the devices (e.g. tags). For example, if two cows are within the reading ranges of the reading devices 18, the reading devices 18 will not be able to discriminate between the devices (e.g. tags) on each cow.

It is to be still further noted that the reading devices 18 have to be placed so that they can obtain readings that can be used to identify the animal 10 (e.g. by reading an ID device 12, or by any other identification method and/or technique) and read the devices (e.g. tags) attached to a single animal at a time. Placement of the reading devices 18 at a position in which due to their reading range they may simultaneously read devices attached to more than one animal may lead to errors in assignment of the devices (e.g. tags). For example, if two cows are within the reading ranges of the reading devices 18, the reading devices 18 will not be able to discriminate between the devices (e.g. tags) on each cow.

Accordingly, the reading devices 18 are placed so that they can obtain readings that can be used to identify the animal 10 (e.g. by reading an ID device 12, or by any other identification method and/or technique) and read the devices (e.g. tags) attached to the animal 10 when the animal is within a confined area 16. The confined area 16 is an area in which only a single cow can be located when the reading devices 18 read the devices (e.g. tags) attached to the animal.

In some cases, the reading devices 18 obtain readings that can be used to identify the animal 10 (whether using an ID tag or by any other means) and read the devices (e.g. tags) that are attached to the animal 10 substantially simultaneously. When reference is made herein to substantially simultaneously, one option is that the readings are made within a range of few seconds or even less than one second. Another option is that the readings are made during a time frame during which the animal 10 is expected to be located at the confined area 16 (for example, if the animal 10 is walking through an animal passage, and the readings are obtained while it is walking, it can be expected that the animal 10 will be located within the confined area 16 for less than a few seconds).

The confined area 16 can be, for example, at least part of feeding station in which a single animal is fed. Additionally, or alternatively, the confined area 16 can be at least part of milking cabin in which a single animal is milked. Additionally, or alternatively, the confined area 16 can be a portion of an animal passage allowing only one of the animals to be located within the confined area 16 during obtainment of readings that can be used to identify the animal 10 (e.g. by reading an ID device 12, or by any other identification method and/or technique) and the readings of the tags attached to the single animal by the reading devices 18. In some cases, the animal passage is a sorting gate.

In some cases, the animal passage comprises conductive rails. In some cases, these conductive rails may create the risk of interacting or interfering with the reading devices 18 operation. For example, the rails may act as an antenna that may conducts signals sent from the reading devices 18 to the devices (e.g. tags) attached to the animals outside the confined area 16, and/or the signals sent from the devices (e.g. tags) attached to the animals outside the confined area 16 in response to excitation by the reading devices 18. Thus, in some cases the reading devices 18 can be insulated from the conductive rails, e.g. using known methods and/or techniques.

It is to be noted that, in some cases, the confined area 16 may be limited to an area that covers the entire reading range of the reading devices 18, so that the tag reading devices 18 cannot obtain readings that can be used to identify animals that are located outside of the confined area 16 and/or readings of tags that are located outside s

In some cases, as further detailed herein, inter alia with reference to FIG. 4, the animal 10 can be identified (e.g. by reading an ID device 12, or by any other identification method and/or technique) and the devices (e.g. tags) attached to the animal 10 can be read more than once, in order to verify that the identification and the obtained readings are accurate. In such cases, such subsequent reading/s can be made by the same reading devices 18, or they can be made by additional reading devices (not shown in the figure) that are also placed so that they can obtain readings that can be used to identify the animal 10 (e.g. by reading an ID device 12, or by any other identification method and/or technique) and read the devices (e.g. tags) attached to the animal 10 when the animal 10 is within a confined area, that can be the same confined area 16 shown in the figure, or another confined area that is not shown in the figure (e.g. another section of the animal passage).

Having described an example of part of the deployment of the system, attention is now drawn to FIG. 2. FIG. 2 is a block diagram schematically illustrating one example of a device assignment system, in accordance with the presently disclosed subject matter.

According to the presently disclosed subject matter, device assignment system 100 comprises one or more reading devices 18, each of which being capable of reading one or more devices (e.g. tags) attached to the animal 10. Due to the fact that the animal 10 can have a plurality of devices attached thereto, it can be appreciated that in those cases where two or more of the devices operate according to different communication or tag reading protocols/techniques, a plurality of reading devices 18 are required, so that the reading devices 18 include at least one reading device for each communication protocol/technique.

As indicated herein, one of the devices that can be attached to an animal 10 is an identification device 12 (e.g. an ID tag). In some cases, the animal 10 can be identified using non-tag based devices and systems, as described herein, such as, but not limited to, facial (or other body part) recognition techniques. In such cases, one or more other devices can be attached to the animal 10, and its identification can be non-tag based (e.g. facial, or other body-part, recognition).

Device assignment system 100 may further comprise a processing circuitry 120. Processing circuitry 120 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant device assignment system 100 resources and for enabling operations related to device assignment system's 100 resources.

Device assignment system 100 can further comprise a network interface 110 (e.g. a network card, a WiFi client, a LiFi client, 3G/4G client, or any other component), enabling device assignment system 100 to communicate over a network with various systems, such as a farm management system 140 in which animal records are kept (as further detailed herein), etc. It is to be noted that in some cases, the animal records are maintained in the device assignment system 100, and in such cases, the device assignment system 100 can optionally be a standalone system that does not have to communicate with an external farm management system 140.

Processing circuitry 120 comprises a device assignment module 130, configured to perform a device assignment process, as further detailed herein, inter alia with reference to FIGS. 3 and 4.

As indicated herein, one or more animal records are kept in a data repository 160. The device assignment system 100 is communicatively connected to the data repository 160. The data repository 160 can be an internal data repository comprised within the device assignment system 100, however it may also be an external data repository. In such cases, the data repository 160 can be part of a management system 140 (e.g. a farm management system), that the device assignment system 100 can communicate with (e.g. via its network interface 110).

In those cases where a management system 140 external to the device assignment system 100 exists, it can comprise a network interface 150 (e.g. a network card, a WiFi client, a LiFi client, 3G/4G client, or any other component), enabling management system 140 to communicate over a network with various systems, such as the device assignment system 100.

Management system 140 can further comprise, or be otherwise associated with, a data repository 160 (e.g. a database, a storage system, a memory including Read Only Memory—ROM, Random Access Memory—RAM, or any other type of memory, etc.) configured to store data, optionally including, inter alia, one or more animal records. Each animal record can be associated with a respective distinct animal and can include various types of information associated therewith, including a unique animal identifier associated with the respective distinct animal, and optionally information identifying one or more devices attached to the animal 10, as further detailed herein. Data repository 160 can be further configured to enable retrieval and/or update and/or deletion of the stored data. It is to be noted that in some cases, data repository 160 can be distributed, while the management system 140 has access to the information stored thereon, e.g. via a wired or wireless network to which management system 140 is able to connect (utilizing its network interface 150).

It is to be noted, as indicated herein, that in some cases the data repository 160 is internal to the device assignment system 100. In other cases, the data repository 160 can be comprised within the devices themselves, so that, for example, one or more of the devices that are attached to an animal 10 can include information identifying one or more other devices attached to the same animal 10, and/or information identifying the animal 10 itself. For example, the identification device 12 that is attached to the animal 10 can include a record comprising an identifier of the monitoring device 14 attached to the same animal 10. In those cases, those devices that include information identifying one or more other devices can be regarded as including their own data repository.

Having described the various components of the device assignment system 100, attention is drawn to FIG. 3, a flowchart illustrating one example of a sequence of operations carried out for device assignment, in accordance with the presently disclosed subject matter.

According to certain examples of the presently disclosed subject matter, device assignment system 100 is configured to perform a device assignment process 200, e.g. utilizing the tag assignment module 130. For this purpose, tag assignment system 100 is configured to obtain an animal identifier (e.g. by reading an ID device 12 such as an ID tag, or using any other identification method and/or technique) and one or more readings from one or more readings obtained by the reading devices 18 from the devices (e.g. tags) attached to the animal 10 (block 210).

In some cases, the obtainment of the animal identifier and of the readings obtained by the reading devices 18 from the devices (e.g. tags) attached to the animal 10 is performed substantially simultaneously, as detailed with reference to FIG. 1.

The animal identifier can be an ID reading of an animal identification device 12 (e.g. an ID tag) attached to a given animal 10, of a plurality of animals, from a reading device of the reading devices 18. In such cases, the ID reading includes at least information uniquely identifying the given animal 10. In other cases, the animal identifier can be obtained from any other device capable of uniquely identifying an animal 10 (e.g. using facial recognition methods and/or techniques).

The one or more readings obtained at block 210 may include a device reading of a device, other than the animal identification device 12, attached to the given animal 10 (e.g. an animal monitoring device 14 such as a monitoring tag). The device reading may be obtained from one of the reading devices 18. In such cases, the device reading includes at least device identification information uniquely identifying the device (e.g. the monitoring device 14) attached to the given animal 10.

As indicated herein, in case two devices are attached to the animal 10 (e.g. the ID device 12 and the monitoring device 14), and assuming that both devices operate according to a common communication protocol, a single reading device 18 can read both devices (while using known techniques for differentiating between the readings, as detailed herein with reference to FIG. 1). However, in case two devices are attached to the animal 10 (e.g. the ID device 12 and the monitoring device 14), however both devices operate according to different communication protocols, each device has to be read by a different reading device 18 operating according to the respective communication protocol (as detailed herein with reference to FIG. 1).

As indicated herein, it is to be noted that in some cases, the ID reading and the device reading are obtained when the given animal 10 is located at a confined area 16 as defined with reference to FIG. 1.

In some cases, device assignment system 100 can be configured to check if the readings failed (block 220), and in such case provide an alert to a user of the device assignment system 100 with a suitable indication (block 230). It is to be noted that a device reading can fail due to various reasons, including, for example, a malfunction of the device, a missing device (as in some cases devices, such as tags, can for example break and fall), etc.

Device assignment system 100 is further configured to cause update of the data repository 160 to assign the device identification information to a given record of the records associated with the unique animal identifier of the given animal 10 (block 240). By doing so, the data repository 160 is automatically updated to indicate that the device identified by the device identification information is attached to the animal 10 that is identified by the obtained animal identifier.

It is to be noted that in some cases, a device that is attached to the animal 10 may be removed (for any reason) from another animal before attachment to the animal 10. Due to the fact that the device was attached to another animal, the data repository 160 may indicate that such device is assigned to such other animal. Accordingly, device assignment system 100 can be further configured to cause another update of the data repository 160 to delete the device identification information from a second record of the records, other than the given record, wherein the second record is not associated with the unique animal identifier of the given animal (block 250).

It is to be noted that in some cases, all, or part, of the device assignment process 200, can be performed by the management system 140, in cooperation with the tag assignment system 100 or by itself.

It is to be further noted, with reference to FIG. 2, that some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Turning to FIG. 4, there is shown another flowchart illustrating another optional part of the sequence of operations carried out for device assignment, in accordance with the presently disclosed subject matter.

According to certain examples of the presently disclosed subject matter, as part of the device assignment process 200, after performance of block 210 or block 220, device assignment system 100, can be configured to again obtain a second animal identifier and one or more second readings from one or more of the reading devices 18 (block 310). The second animal identifier and the one or more second readings obtained at block 310 can be obtained from the same origin (e.g. from the same reading devices 18), at different points in time, or from other origins (e.g. other reading devices) simultaneously, or at different points in time.

In some cases, the obtainment of the second animal identified and of the second readings is performed substantially simultaneously, as detailed with reference to FIG. 1.

The second animal identifier can be an ID reading of an animal identification device 12 (e.g. an ID tag) attached to the given animal 10, from a reading device of the tag reading devices 18. In such cases, the second ID reading includes at least information uniquely identifying the given animal 10. In other cases, the animal identifier can be obtained from any other device capable of uniquely identifying an animal 10 (e.g. using facial recognition methods and/or techniques).

The one or more readings obtained at block 310 include a second device reading of the device attached to the given animal 10 that is not an animal identification ta device g 12 (e.g. an animal monitoring device 14, such as a monitoring tag). The second device reading is obtained from one of the reading devices 18. In such cases, the second device reading includes at least device identification information uniquely identifying the second device attached to the given animal 10.

As indicated herein, it is to be noted that in some cases, the ID reading and the device reading are obtained when the given animal 10 is located at the confined area 16 as defined with reference to FIG. 1, or at another confined area (e.g. another part of the animal passage) that meets the same requirements of a confined area as defiled with reference to FIG. 1.

After obtainment of the information at block 310, the device assignment system 100 can be configured to check if the readings match (block 320). That is, the device assignment system 100 is configured to verify that (a) the unique animal identifier included in the second ID reading obtained at block 310 is identical to the unique animal identifier included in the ID reading obtained at block 210, and (b) that the device identification information included in the second readings obtained at block 310 is identical to the device identification information included in the device readings obtained at block 210.

In case of a mismatch, the device assignment system 100 can be configured to perform an action, such as provide a notification to a user of the device assignment system 100, mark the animal to be checked, etc. (block 330). In case no mismatch exists, the device assignment process 200 can proceed to block 220 or 240, so that the causing of the update of the data repository is performed only in case of a match between the values of the readings (identical animal identifier and identical device identification information).

It is to be noted, with reference to FIG. 4, that some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed methods. The presently disclosed subject matter further contemplates a machine-readable memory tangibly embodying a program of instructions executable by the machine for executing the disclosed methods.

1. A tag assignment system, comprising:
one or more tag reading devices capable of reading tags attached to animals;
one or more visual reading devices capable of visually identifying animals; and
a processing circuitry;
wherein:
(a) the tag assignment system is communicatively connected to a data repository comprising one or more records, each of the records (i) being associated with a respective distinct animal of a plurality of animals, and (ii) including a unique animal identifier associated with the respective distinct animal; and
(b) the processing circuitry is configured to:
substantially simultaneously: (i) obtain, utilizing a visual reading device of the visual reading devices, an ID reading of an animal identifier including at least the unique animal identifier uniquely identifying the given animal, and (ii) obtain a tag reading of a tag attached to the given animal from a tag reading device of the tag reading devices, wherein the tag reading including at least tag identification information uniquely identifying the second tag attached to the given animal; and
cause update of the data repository to assign the tag identification information to a given record of the records associated with the unique animal identifier of the given animal.

2. The tag assignment system of claim 1, wherein the visual reading device is a camera and wherein the ID reading is obtained by visually identifying the given animal or by visually identifying passive tags, uniquely identifying the given animal, on the given animal.

3. The tag assignment system of claim 1, wherein the processing circuitry is further configured to cause a second update of the data repository to delete the tag identification information from a second record of the records, other than the given record, wherein the second record is not associated with the unique animal identifier of the given animal.

4. The tag assignment system of claim 1, wherein the tag is a Radio Frequency Identification (RFID) tag or an Infra-Red (IR) tag.

5. The tag assignment system of claim 1, wherein the ID reading and the tag reading are obtained when the given animal is located at a confined area, so that the tag is within a reading range of the tag reading device.

6. The tag assignment system of claim 5, wherein the confined area is: (a) within a feeding station, (b) within a milking cabin, (c) a portion of an animal passage allowing only one of the animals to be located within the confined area during obtainment of the ID reading and the tag reading, or (d) is an area defined by the reading range.

7. The tag assignment system of claim 6, wherein the animal passage is a sorting gate.

8. The tag assignment system of claim 5, wherein the confined area is an area defined by the reading range.

9. The tag assignment system of claim 6, wherein the animal passage comprises conductive rails, and wherein the tag reading device is insulated from the conductive rails.

10. The tag assignment system of claim 1, wherein the processing circuitry is further configured, after the substantially simultaneous obtainment, to substantially simultaneously: (a) obtain, from a second visual reading device of the visual reading device, a second ID reading of the animal identifier of the given animal, wherein the second ID reading including at least the unique animal identifier uniquely identifying the given animal, and (b) obtain a second tag reading of the tag attached to the given animal from a second tag reading device of the tag reading devices, wherein the second tag reading including at least the tag identification information uniquely identifying the tag attached to the given animal; and
wherein causing the update of the data repository is made upon the ID reading being identical to the second ID reading and the tag reading being identical to the second tag reading.

11. The tag assignment system of claim 1, wherein the processing circuitry is further configured to alert a user upon failure to obtain the ID reading or the tag reading.

12. A tag assignment method, comprising:
substantially simultaneously: (i) obtaining from a visual reading device of one or more visual reading devices capable of visually identifying animals, an ID reading of an animal identifier including at least the unique animal identifier uniquely identifying the given, and (ii) obtaining a tag reading of a tag attached to the given animal from a tag reading device of one or more tag reading devices capable of reading tags attached to animals, wherein the tag reading including at least tag identification information uniquely identifying the second tag attached to the given animal; and
causing update of a data repository comprising one or more records, each of the records (i) being associated with a respective distinct animal of a plurality of animals, and (ii) including a unique animal identifier associated with the respective distinct animal, wherein the update includes assigning the tag identification information to a given record of the records associated with the unique animal identifier of the given animal.

13. The tag assignment method of claim 11, wherein the visual reading device is a camera and wherein the ID reading is obtained by visually identifying the given animal or by visually identifying passive tags, uniquely identifying the given animal, on the given animal.

14. The tag assignment method of claim 11, further comprising causing a second update of the data repository to delete the tag identification information from a second record of the records, other than the given record, wherein the second record is not associated with the unique animal identifier of the given animal.

15. The tag assignment method of claim 11, wherein the tag is a Radio Frequency Identification (RFID) tag or an Infra-Red (IR) tag.

16. The tag assignment method of claim 11, wherein the ID reading and the tag reading are obtained when the given animal is located at a confined area, so that the tag is within a reading range of the tag reading device.

17. The tag assignment method of claim 16, wherein the confined area is: (a) within a feeding station, (b) within a milking cabin, (c) a portion of an animal passage allowing only one of the animals to be located within the confined area during obtainment of the ID reading and the tag reading, or (d) is an area defined by the reading range.

18. The tag assignment method of claim 17, wherein the animal passage is a sorting gate.

19. The tag assignment method of claim 16, wherein the confined area is an area defined by the reading range.

20. The tag assignment method of claim 17, wherein the animal passage comprises conductive rails, and wherein the tag reading device is insulated from the conductive rails.

21. The tag assignment method of claim 11, further comprising, after the substantially simultaneous obtainment, substantially simultaneously: (a) obtaining, from a second visual reading device of the visual reading device, a second ID reading of the animal identifier of the given animal, wherein the second ID reading including at least the unique animal identifier uniquely identifying the given animal, and (b) obtaining a second tag reading of the tag attached to the given animal from a second tag reading device of the tag reading devices, wherein the second tag reading including at least the tag identification information uniquely identifying the tag attached to the given animal; and
wherein causing the update of the data repository is made upon the ID reading being identical to the second ID reading and the tag reading being identical to the second tag reading.

22. The tag assignment method of claim 21, further comprising alerting a user upon failure of obtaining the ID reading or the tag reading.

23. A non-transitory computer readable storage medium having computer readable program code embodied therewith, the computer readable program code, executable by at least one processing circuitry of a computer to perform a method comprising:
substantially simultaneously: (i) obtaining from a visual reading device of one or more visual reading devices capable of visually identifying animals, an ID reading of an animal identifier including at least the unique animal identifier uniquely identifying the given, and (ii) obtaining a tag reading of a tag attached to the given animal from a tag reading device of one or more tag reading devices capable of reading tags attached to animals, wherein the tag reading including at least tag identification information uniquely identifying the second tag attached to the given animal; and
causing update of a data repository comprising one or more records, each of the records (i) being associated with a respective distinct animal of a plurality of animals, and (ii) including a unique animal identifier associated with the respective distinct animal, wherein the update includes assigning the tag identification information to a given record of the records associated with the unique animal identifier of the given animal.
